(19) United States
(12) Patent Application Publication
(10) Pub. No.: US 2004/0057726 A1
(43) Pub. Date: Mar. 25, 2004

(54) Optical cross-connect unit of multigranular architecture

(75) Inventors: Denis Penninckx, Nozay (FR); Ludovic Noirie, Nozay (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/663,808

(22) Filed: Sep. 17, 2003

(30) Foreign Application Priority Data
Sep. 19, 2002 (FR) 02 11 598

(51) Int. Cl. H04J 14/00

(52) U.S. Cl. 398/50

(57) ABSTRACT

The present invention relates to an optical cross-connect unit of multigranular architecture (1000) including a first stage (100) for switching wavelength bands and including an optical switching matrix for switching wavelength bands, demultiplexing and multiplexer means (10 to 20′)for demultiplexing and multiplexing wavelength bands, a second stage (200) for switching wavelengths and including a switching matrix for switching wavelengths, and demultiplexing and multiplexer means (30 to 60′) for demultiplexing and multiplexing wavelengths. The first matrix of the invention includes a series of first optical switching submatrices (1, 2) disposed in parallel and the second matrix of the invention includes a series of second switching submatrices (3, 4) disposed in parallel.

The present invention relates to an optical cross-connect unit of multigranular architecture intended to be used in a communications node of an optical telecommunications network.

Optical telecommunications networks are intended to convey very large quantities of digital traffic on continental and intercontinental scales, for example for Internet multimedia applications. At present optical technology provides bit rates of the order of one terabit per second (10¹² bits per second) on a single fiber, which is still short of the theoretical limits, which are much higher. This technology is therefore the future solution for the exchange of high density information, especially voice and video.

Prior art optical telecommunications networks using the principle of switching include communications nodes provided with high-speed cross-connect units for switching groups of optical signals carrying digital data, generally by amplitude modulation of carrier light waves.

The document “Multigranularity Optical Cross-Connect” by L. Noirie et al., Paper 9.2.4, European Conference on Optical Communication 2001, Munich, Germany, 3-7 Sep. 2001, describes an optical cross-connect unit with three degrees of granularity, i.e. capable of routing groups of data with a common destination at wavelength level, at wavelength band level, and at optical fiber level.

The multigranular approach increases the capacity of the transmission network while retaining a level of switching complexity that remains reasonable.

A cross-connect unit of the above kind comprises three optical switching stages: a stage dedicated to wavelengths, a stage dedicated to wavelength bands, and a stage dedicated to optical fibers. Each stage uses an optical switching matrix whose function is to direct groups of digital optical signals by means of respective sets of input ports and output ports.

The optical switching matrix for switching wavelength bands has first input ports, each of which receives digital optical signals grouped in a common band of wavelengths and coming from the stage dedicated to optical fibers, and has first output ports, each of which delivers optical signals grouped in the same wavelength band to the stage dedicated to optical fibers.

In one of the embodiments described, the optical switching matrix for switching wavelength bands has second output ports that are connected to first input ports of the optical switching matrix for switching wavelengths via wavelength division demultiplexer means. Similarly, this matrix has second input ports which are connected to first output ports of the optical switching matrix for switching wavelengths via wavelength division multiplexer means.

Because of these direct connections between the stage dedicated to wavelength bands and the stage dedicated to wavelengths, it is possible to rearrange the data between distinct bands (transfer of data, exchange of data, etc.) dynamically, which is known as grooming.

Furthermore, the switching matrix for switching wavelength bands has third input ports adapted to receive wavelength bands sent by a local area network connected to the communications node associated with the cross-connect unit and third output ports adapted to send wavelength bands to the local area network. The switching matrix for switching wavelengths has the same type of input port and output port.

The optical switching matrices for switching wavelengths and wavelength bands have a large number of input and output ports, which increases their manufacturing cost and the cost of their interfaces.

Moreover, within the optical switching matrix for switching wavelength bands, in order to prevent mixing, not all optical paths between the input ports and the output ports are authorized. This is because there are at present no means for wavelength band conversion, as is needed to groom the data directly between distinct bands. A large optical switching matrix for switching wavelength bands is therefore of little advantage.

An object of the present invention is to provide an optical cross-connect unit of multigranular architecture having at least one switching stage for switching wavelengths and one switching stage for switching wavelength bands, and which is of relatively low cost, suitable for all types of traffic, and preferably suitable for grooming between distinct bands.

To this end, the invention provides an optical cross-connect unit of multigranular architecture comprising:

a first stage for switching wavelength bands and comprising:

a switching optical matrix (also known as the first matrix) for switching wavelength bands and having first input ports (also known as switch ports) and first output ports (also known as switch ports) and second input ports (also known as redirection ports) and second output ports (also known as redirection ports),

demultiplexer means for demultiplexing wavelength bands and having p groups of n outputs associated with n distinct wavelength bands, each output being connected to a distinct input switch port of the first matrix,

multiplexer means for multiplexing wavelength bands and having p groups of n inputs each connected to a distinct output switch port of the first matrix,

a second stage for switching wavelengths and comprising:

a switching matrix (also known as the second matrix) for switching wavelengths and having first input ports (also known as switch ports) and first output ports (also known as switch ports),

demultiplexer means for demultiplexing wavelengths and each input of which is connected to a distinct output redirection port of the first matrix and each output of which is connected to a distinct input switch port of the second matrix, and

multiplexer means for multiplexing wavelengths and each input of which is connected to a distinct output switch port of the second matrix and each output of which is connected to a distinct input redirection port of the first matrix,

which cross-connect unit is characterized in that the first matrix includes a series of first optical switching submatrices disposed in parallel and the second matrix includes a series of second switching submatrices disposed in parallel.

Using small submatrixes saves on ports without degrading the performance of the cross-connect unit of the invention.

In an advantageous embodiment, said first submatrices include n first submatrices, each dedicated to a distinct one of said n wavelength bands and including p of said input switch ports and p of said output switch ports, and at least two of the first submatrices (also known as redirection submatrices), each of which includes at least one distinct input redirection port and at least one distinct output redirection port, and each of which is coupled to a distinct one of said second submatrices.

Accordingly, each redirection submatrix is associated with a predetermined second submatrix. This enables data to be groomed between identical wavelength bands conveyed by distinct fibers.

Preferably, each of at least two of the second submatrices includes at least one inter-input-matrix communications port and at least one inter-output-matrix communications port, each inter-input-matrix communications port being adapted to receive an information carrier signal from one of said second submatrices and each inter-output-matrix communications port being adapted to deliver an information carrier signal addressed to one of said second submatrices.

The information carrier signal may be a digital or analog optical or electrical signal, depending on the nature of the second submatrices and their interfaces.

The input matrix/output matrix communications ports convert one or more wavelengths of a band to another band and therefore groom the information between bands, for example to fill a partially-unoccupied band.

Advantageously, for correct routing of information carrier signals, the cross-connect unit may include intermatrix switching means coupling all of said inter-input-matrix communications ports to all of said inter-output-matrix communications ports.

In a preferred embodiment, the information carrier signals are optical signals and the cross-connect unit may include an optical concentrator for concentrating optical signals coupling all the inter-output-matrix communications ports to the inputs of the intermatrix switching means and an optical deconcentrator for deconcentrating optical signals coupling the outputs of the intermatrix communications means to all the inter-input-matrix communications ports.

If the intermatrix communications ports cannot all be used simultaneously, the number of inputs and outputs of the intermatrix switching means can be reduced, if necessary, by using concentrators and deconcentrators in accordance with the invention.

In a first embodiment of the invention, the information carrier signals are optical signals and the intermatrix switching means may include wavelength conversion means.

In a second embodiment of the invention, the information carrier signals are optical signals and the cross-connect unit includes wavelength conversion means and preferably includes 3R regenerators when the information carrier signals are digital signals, said means being disposed between output switch ports of the second submatrices and the wavelength multiplexer means.

A 3R (Retiming, Reshaping, Reamplification) regenerator provides the wavelength conversion function at the same time as the retiming (resynchronization), reshaping and reamplification functions in respect of a digital optical signal.

If the second submatrices are electrical, then optical-electrical and electrical-optical converters may be respectively disposed at least at the level of the input switch ports and at least at the level of the output switch ports of said second submatrices.

The cross-connect unit may preferably include an optical concentrator whose inputs are connected to a set of output ports (also known as drop ports) of said second submatrices and an optical deconcentrator whose outputs are connected to a set of input ports (also known as add ports) of said second submatrices.

Features and objects of the present invention emerge from the following detailed description, which is given with reference to accompanying drawings, which are provided by way of illustrative and non-limiting example.

In the figures:

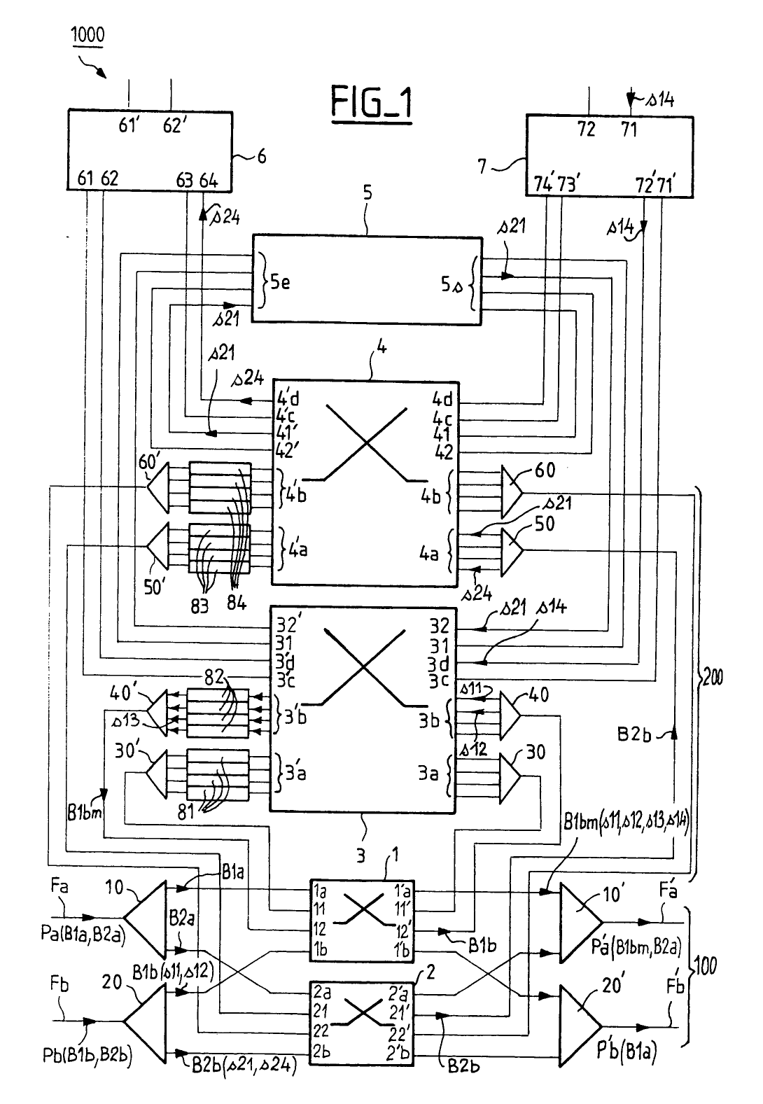

FIG. 1 shows diagrammatically a first preferred embodiment of a digital optical signal optical cross-connect unit 1000 of the invention,

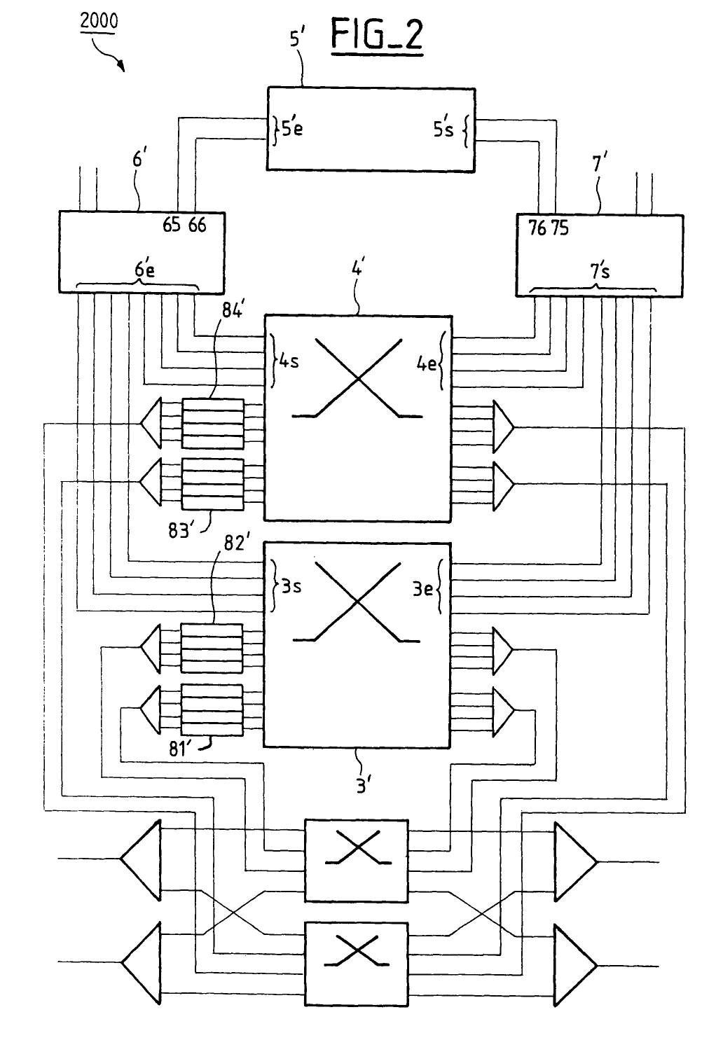

FIG. 2 shows diagrammatically a second preferred embodiment of a digital optical signal optical cross-connect unit 2000 of the invention, and

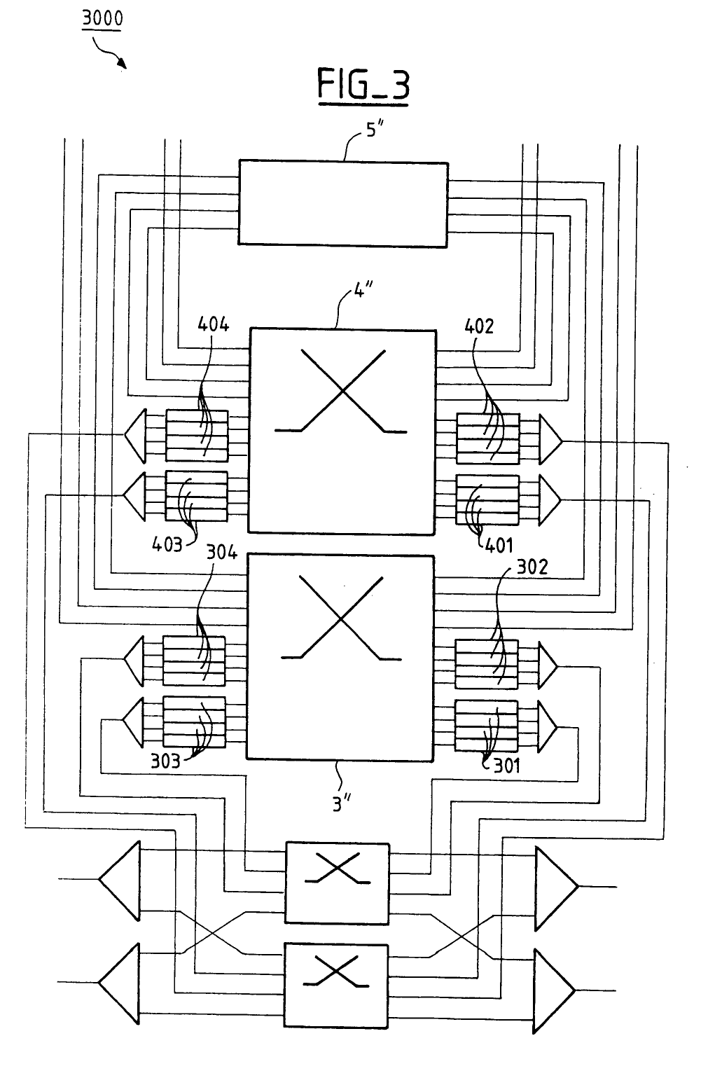

FIG. 3 shows diagrammatically a third preferred embodiment of a digital optical signal optical cross-connect unit 3000 of the invention.

FIG. 1 shows diagrammatically a first preferred embodiment of an optical cross-connect unit of multigranular architecture 1000 of the invention for optical signals carrying information, for example in the form of digital data. Each digital optical signal is in the form of a modulated, for example amplitude-modulated, carrier optical wave.

The cross-connect unit 1000 has a first stage 100 for switching wavelength bands and a second stage 200 for switching wavelengths.

The first stage 100 comprises an optical switching matrix for switching wavelength bands, taking the form of a pair of first optical switching submatrices 1,2 disposed in parallel. Each is dedicated to a respective distinct wavelength band B1, B2, each of which comprises four wavelengths λ11, λ12, λ13, λ14 and λ21, λ22, λ23, λ24, respectively, for example, usable for carrying digital data.

The first submatrices 1, 2, which are redirection submatrices, have two input switch ports 1a, 1b and 2a, 2b, respectively and two output switch ports 1′a, 1′b and 2′a, 2′b, respectively.

The number of input and output switch ports corresponds to the number of input optical fibers Fa, Fb and output optical fibers F′a, F′b connected to the switch ports via demultiplexer means 10, 20 for demultiplexing wavelength bands and multiplexer means 10′, 20′ for multiplexing wavelength bands.

The invention also applies to a situation in which there is only one input fiber and one output fiber. The input and output fibers can be the line optical fibers themselves or connecting fibers if the cross-connect unit 1000 includes a dedicated stage at the fiber level, for example analogous to that of the prior art.

Moreover, the redirection submatrices 1, 2 have two input redirection ports 11, 12 and 21, 22, respectively, and two output redirection ports 11′, 12′ and 21′, 22′, respectively.

Either or both redirection submatrices could have a single input redirection port and a single output redirection port. The choice of the number of ports depends on network parameters.

Moreover, in a situation where the input and output fibers carry more than two wavelength bands, one or more other first optical switching matrices that do not necessarily include redirection ports are added in parallel.

Furthermore, the input of the either or both of the redirection submatrices 1, 2 can be provided with one or more band add ports (not shown) at the input and one or more band drop ports (not shown) at the output.

The second stage 200 includes an optical switching matrix for switching wavelengths taking the form of a pair of second optical submatrices 3, 4 respectively coupled to distinct redirection submatrices 1, 2.

On the input side, the second submatrices 3, 4 have two groups of four input switch ports 3a, 3b and 4a, 4b, respectively, which are connected to distinct output redirection ports 11′, 12′ and 21′, 22′, respectively, via wavelength division demultiplexer means 30, 40 and 50, 60, respectively.

On the output side, the second submatrices 3, 4 include two groups of four output switch ports 3′a, 3′b and 4′a, 4′b, respectively, which are connected to distinct output redirection ports 11, 12 and 21, 22, respectively, via wavelength division demultiplexer means 30′, 40′ and 50′, 60′, respectively.

Moreover, the second submatrices 3, 4 have at their input two wavelength add ports 3c, 3d and 4c, 4d, respectively. The number of add ports can be set to a value from 1 to 8, the value 8 corresponding to the maximum possible number of wavelengths passing through the two redirection ports.

The second submatrices 3, 4 have at their output two wavelength drop ports 3′c, 3′d and 4′c, 4′d, respectively.

All the add ports 3c, 3d, 4c, 4d are connected to the outputs 71′ to 74′ of an optical deconcentrator 7 having two inputs 71, 72 connected to a local area network (not shown).

All the drop ports 3′c, 3′d, 4′c, 4′d are connected to the inputs 61 to 64 of an optical concentrator 6 having two outputs 61′, 62′ connected to a local area network (not shown).

Finally, the second submatrices 3, 4 have two inter-input-matrix communications ports 31, 32 and 41, 42, respectively, and two inter-output-matrix communications ports 31′, 32′ and 41′, 42′, respectively. The number of intermatrix communications ports can be set to a value between 1 and 8 as a function of what is required.

Each inter-input-matrix switch port of one or the other of the second submatrices is adapted to receive a digital optical signal from one of the distinct second submatrices 3, 4 and similarly each inter-output-matrix communications port of either of the second submatrices 3, 4 is adapted to deliver a digital optical signal addressed to another of said second submatrices.

Optical intermatrix switching means 5 couple the inter-input-matrix communications ports 31, 32, 41, 42 connected to its inputs 5e to all of said inter-output-matrix communications ports 31′, 32′, 41′, 42′ connected to its outputs 5s.

Four series of four 3R regenerators 81 to 84 are disposed between the output switch ports 3′a to 4′b of the second submatrices 3, 4 and the wavelength division multiplexer means 30′ to 60′.

An example of the operation of the cross-connect unit 1000 is described next.

Two groups Pa, Pb of digital optical signals conveyed by the fibers Fa, Fb contain the same two wavelength bands B1, B2.

The signals of the groups Pa, Pb are demultiplexed at the wavelength band level by the demultiplexer means 10, 20. The signals B1a, B2a, B1b, B2b grouped by band are referred to as composite signals and are labeled in FIG. 1 with reference to their band.

The composite signals B1a, B2a are switched by the first submatrices 1, 2, respectively, dedicated to their band and are fed to multiplexer means 20′, 10′ for multiplexing wavelength bands

The composite signal B1b delivered by the output redirection port 12′ passes through the demultiplexer means 40 for demultiplexing wavelengths, which separate it into two digital optical signals s11, s12 with distinct carrier wavelengths λ11, λ12. The digital signals s11, s12 are directed to output switch ports of the group 3′b.

A digital optical signal s14 with a carrier wavelength λ14, for example, passes through the optical deconcentrator 7, is injected into the second submatrix 3 via the add port 3d, and exits via an output switch port of the group 3′b.

The composite signal B2b delivered by the output redirection port 21′ passes through the demultiplexer means 50 for demultiplexing wavelengths, which separate it into two digital optical signals s21, s24 with distinct carrier wavelengths λ21, λ24.

The digital signal s21 delivered by one of the inter-output-matrix communications ports 41′ of the second submatrix 4 passes through the intermatrix optical switching means 5, which route it to one of the inter-input-matrix communications ports 32 of the second submatrix 3.

The digital signal s24 is delivered to the concentrator 6 by one of the drop ports 4′d of the second submatrix 4.

On the output side of the second submatrix 3, the digital signals s11, s12, s13, s14 each pass through 3R optical regeneration means of the series 82. The signal s21 is converted into a digital data carrier optical signal s13 at the wavelength λ13. These signals s11, s12, s13, s14 are multiplexed by the multiplexer means 40′ for multiplexing wavelengths to form a groomed composite signal B1bm.

The multiplexer means 10′, 20′ for multiplexing wavelength bands form two groups P′a, P′b of signals from the composite signals B1bm, B2a and B1a, respectively.

In a variant of this first embodiment, the optical signals are analog signals and the 3R regenerators are therefore replaced by wavelength conversion means, possibly with a regeneration function.

FIG. 2 shows diagrammatically a second preferred embodiment of an optical cross-connect unit 2000 of the invention for digital optical signals.

Only components different from those of the first embodiment are identified by reference numbers.

The optical cross-connect unit 2000 includes an optical switching matrix in the form of a pair of second optical submatrices 3′, 4′ respectively coupled to a distinct redirection submatrix.

One of the second submatrices 3′ has:

four input ports 3e used either as wavelength add ports or as inter-input-matrix communications ports, and

four output ports 3s used either as wavelength drop ports or as inter-output-matrix communications ports.

In the same manner, the other second submatrix 4′ has four input ports 4e and four output ports 4s with two functions, for example.

All the output ports 3s, 4s (excluding the switch ports) are connected to the inputs 6′e of an optical concentrator 6′ whose output is connected to a local area network (not shown). Two outputs 65, 66 used for the circulation of digital optical signals between submatrices are connected to the inputs of intermatrix optical switching means 5′ whose two outputs 5′s are connected to inputs 75, 76 of an optical deconcentrator 7′ whose input is also connected to a local area network (not shown). All the input ports 3e, 4e (excluding the switch ports) are connected to the outputs 7′s of the optical deconcentrator 7′.

The intermatrix optical switching means 5′ are provided with wavelength conversion means (not shown) for grooming data between distinct bands, for example.

Furthermore, the four series 81 to 84 of four 3R optical regenerators are replaced by four series 81′ to 84′ of four standard optical amplifiers.

FIG. 3 shows diagrammatically a third preferred embodiment of an optical cross-connect unit 3000 of the invention for digital optical and electrical signals only components differing from those of the first embodiment are identified by reference numbers.

The optical cross-connect unit 3000 includes an electrical switching matrix in the form of a pair of second electrical submatrices 3″, 4″, respectively coupled to a distinct redirection submatrix.

Four series 301, 302, 401, 402 of optical-electrical converters and four series of electrical-optical converters 303, 304, 403, 404 are disposed at the level of the input switch ports and at the level of the output switch ports of the second submatrices 3″ and 4″, respectively. The electrical-optical converters replace the 3R regenerators.

Electrical intermatrix switching means 5″ couple all the inter-input-matrix communications ports to all the inter-output-matrix communications ports of the second submatrices, each inter-input-matrix communications port being adapted to receive an electrical digital signal from the other second submatrix.

The use of concentrators and deconcentrators is not necessary in this third embodiment of the invention.

Of course, the invention is not limited to the embodiments that have just been described.

The number of fibers, the number of bands per fiber, the number of wavelengths per band, the number of add ports and drop ports and the number of intermatrix communications ports have been chosen by way of example, and can be adapted as a function of requirements (for example traffic density, number of groomings to be effected, etc.).

The second submatrices can also be of the black and white type, i.e. optical submatrices but with low-cost interfaces whose wavelengths are not perfectly fixed and which do not allow use of the WDM technique within the submatrices.

The number of output ports of the concentrator and the number of input ports of the deconcentrator are chosen as a function of the fluctuations of the traffic and its mean level.

Finally, any means can be replaced by equivalent means without departing from the scope of the invention.

What is claimed is:

1. An optical cross-connect unit of multigranular architecture (1000, 2000, 3000) comprising:
a first stage (100) for switching wavelength bands and comprising:
a switching optical matrix (also known as the first matrix) for switching wavelength bands and having first input ports (also known as switch ports) (1a to 2b) and first output ports (also known as switch ports) (1′a to 2′b) and second input ports (also known as redirection ports) (11 to 22) and second output ports (also known as redirection ports) (11′ to 22′),
demultiplexer means (10, 20) for demultiplexing wavelength bands and having p groups of n outputs associated with n distinct wavelength bands, each output being connected to a distinct input switch port of the first matrix,
multiplexer means (10′, 20′) for multiplexing wavelength bands and having p groups of n inputs each connected to a distinct output switch port of the first matrix,
a second stage (200) for switching wavelengths and comprising:
a switching matrix (also known as second matrix) for switching wavelengths and having first input ports (also known as switch ports) (3a to 4b) and first output ports (also known as switch ports) (3′a to 4′b),
demultiplexer means (30, 60) for demultiplexing wavelengths and each input of which is connected to a distinct output redirection port of the first matrix and each output of which is connected to a distinct input switch port of the second matrix, and
multiplexer means (30′, 60′) for multiplexing wavelengths and each input of which is connected to a distinct output switch port of the second matrix and each output of which is connected to a distinct input redirection port of the first matrix,
which cross-connect unit is characterized in that the first matrix includes a series of first optical switching submatrices (1, 2) disposed in parallel and the second matrix includes a series of second switching submatrices (3 to 4″) disposed in parallel.

2. A cross-connect unit (1000, 2000, 3000) according to claim 1, characterized in that said first submatrices (1, 2) include n first submatrices, each dedicated to a distinct one of said n wavelength bands and including p of said input switch ports and p of said output switch ports, and at least two of the first submatrices (also known as redirection submatrices), each of which includes at least one distinct input redirection port and at least one distinct output redirection port, and each of which is coupled to a distinct one of said second submatrices (3 to 4″).

3. A cross-connect unit (1000, 2000, 3000) according to claim 1, characterized in that each of at least two of the second submatrices (3 to 4″) includes at least one inter-input-matrix communications port (41, 42, 4e) and at least one inter-output-matrix communications port (41′, 42′, 4s), each inter-input-matrix communications port being adapted to receive an information carrier signal from one of said second submatrices and each inter-output-matrix communications port being adapted to deliver an information carrier signal addressed to one of said second submatrices.

4. A cross-connect unit (1000, 2000, 3000) according to claim 3, characterized in that it includes intermatrix switching means (5, 5′, 5″) coupling all of said inter-input-matrix communications ports to all of said inter-output-matrix communications ports.

5. A cross-connect unit (2000) according to claim 4, characterized in that the information carrier signals are optical signals and the cross-connect unit can include an optical concentrator (6′) for concentrating optical signals coupling all the inter-output-matrix communications ports to the inputs of the intermatrix switching means (5′) and an optical deconcentrator (7′) for deconcentrating optical signals coupling the outputs of the intermatrix communications means to all the inter-input-matrix communications ports.

6. A cross-connect unit (2000) according to claim 4, characterized in that the information carrier signals are optical signals and the intermatrix switching means (5′) can include wavelength conversion means.

7. A cross-connect unit (1000) according to claim 1, characterized in that it includes wavelength conversion means and preferably includes 3R regenerators (81 to 84) when the information carrier signals are optical digital signals, said means being disposed between output switch ports of the second submatrices (3, 4) and the wavelength multiplexer means (40 to 60).

8. A cross-connect unit (3000) according to claim 1, characterized in that said second submatrices (3″, 4″) are electrical and optical-electrical converters (301 to 402) and electrical-optical converters (303 to 404) are respectively disposed at least at the level of the input switch ports and at least at the level of the output switch ports of said second submatrices.

9. A cross-connect unit (1000) according to claim 1, characterized in that it includes an optical concentrator (6) whose inputs (61 to 64) are connected to a set of output ports (also known as extraction ports) (3′c to 4′d) of said second submatrices and an optical deconcentrator (7) whose outputs (71′ to 74′) are connected to a set of input ports (also known as insertion ports) (3c to 4d) of said second submatrices.
